(19) United States
(12) Patent Application Publication
(10) Pub. No.: US 2026/0170844 A1
(43) Pub. Date: Jun. 18, 2026

(54) FLOOR STAIN RECOGNITION METHOD AND APPARATUS, AND AUTOMATIC CLEANING DEVICE

(71) Applicant: Beijing Roborock Innovation Technology Co., Ltd., Beijing (CN)

(72) Inventors: Wenxiu SUN, Beijing (CN); Weiyan CAI, Beijing (CN); Rui WANG, Beijing (CN); Yuan GAO, Beijing (CN); Mingli GUO, Beijing (CN)

(21) Appl. No.: 19/535,262

(22) Filed: Feb. 10, 2026

Related U.S. Application Data
(63) Continuation of application No. PCT/CN2024/119736, filed on Sep. 19, 2024.

(30) Foreign Application Priority Data
Aug. 25, 2023 (CN) 202311084777.6

(51) Int. Cl. G06V 20/56; A47L 9/28; A47L 11/40; G06T 7/33; G06T 7/521; G06T 7/55; G06T 7/73; G06V 10/26; G06V 10/40; G06V 10/762; G06V 10/764

(52) U.S. Cl. CPC G06V 20/56; A47L 9/2815; A47L 9/2852; A47L 11/4011; A47L 11/4061; G06T 7/337; G06T 7/521; G06T 7/55; G06T 7/74; G06V 10/26; G06V 10/40; G06V 10/762; G06V 10/764; A47L 2201/04; A47L 2201/06; G06T 2207/10012; G06T 2207/10024; G06T 2207/10028; G06T 2207/10048; G06T 2207/20081; G06T 2207/20221; G06T 2207/30252; G06V 2201/07

(57) ABSTRACT

A floor stain recognition method and apparatus and an automatic cleaning device are disclosed. The method includes: acquiring an RGB image of a field of view; acquiring a depth image of the field of view; acquiring an image common area of view based on the RGB image and the depth image; and acquiring spatial coordinates of a stain area based on the image common area of view. The method can detect the type and position of a stain accurately.

### CROSS REFERENCE TO RELATED APPLICATION

The present application is a Continuation application of International Application No. PCT/CN2024/119736 filed on Sep. 19, 2024, which claims priority to Chinese Patent Application No. 202311084777.6 filed on Aug. 25, 2023, the entire contents of both are incorporated herein by reference.

### TECHNICAL FIELD

The present application relates to the technical field of automatic cleaning devices, and in particular, to an obstacle avoidance method and apparatus of an automatic cleaning device and the automatic cleaning device.

### BACKGROUND OF THE INVENTION

Automatic cleaning devices often encounter the scene of floor stains in operation, and need to accurately detect types and positions of the floor stains for avoiding or cleaning. Generally, RGB (red, green and blue) image detection is a main method for stain detection on the floor. There are many types of floor stains, and most of sweeping and automatic cleaning devices on the current market can only roughly cluster and segment the stains in images during sweeping, and are unable to determine the stain types and clean the stains effectively.

### SUMMARY OF THE INVENTION

In a first aspect, an embodiment of the present application provides a floor stain recognition method. The method includes:
acquiring an RGB image of a field of view;
acquiring a depth image of the field of view;
acquiring an image common area of view based on the RGB image and the depth image; and
acquiring spatial coordinates of a stain area based on the image common area of view.

In a second aspect, an embodiment of the present application further provides a floor stain recognition apparatus. The apparatus includes:
a first recognition module configured to acquire an RGB image of a field of view;
a second recognition module configured to acquire a depth image of the field of view;
an image alignment module configured to acquire an image common area of view based on the RGB image and the depth image; and
a coordinate calculation module configured to acquire spatial coordinates of the stain area based on the image common area of view.

In a third aspect, an embodiment of the present application further provides an automatic cleaning device. The automatic cleaning device includes an automatic cleaning device body and a floor stain recognition apparatus for controlling the automatic cleaning device body, the floor stain recognition apparatus adopting the floor stain recognition method according to the first aspect.

### BRIEF DESCRIPTION OF DRAWINGS

The accompanying drawings described herein are provided to further understand the present application and form a part of the present application. The schematic embodiments of the present application and their descriptions are used to explain the present application and do not form undue limitations on the present application. In the accompanying drawings:

FIG. 1 shows a schematic flowchart of a floor stain recognition method according to a first embodiment of the present application.

FIG. 2 shows a schematic structural diagram of a floor stain recognition apparatus according to a second embodiment of the present application.

### DETAILED DESCRIPTION

The technical solutions of the present application will be described clearly and completely with reference to specific embodiments and corresponding accompanying drawings of the present application, to present the objects, technical solutions, and advantages of the present application more clearly. It is apparent that the described embodiments are only a part not all of the embodiments of the present application. Based on the embodiments in the present application, all of other embodiments obtained by a person of ordinary skill in the art without paying creative labor belong to the protection scope of the present application.

In the following, the technical solutions according to the embodiments of the present application will be described in detail in combination with the accompanying drawings.

An automatic cleaning device, also known as an automatic sweeper, an automatic cleaner, an intelligent vacuum cleaner, an automatic cleaning device vacuum cleaner, or a mobile automatic cleaning device, is a type of intelligent household appliances, and can automatically complete the floor cleaning work in a room by virtue of certain artificial intelligence. Generally, the ways such as sweeping and vacuuming are adopted to suck floor debris into an own garbage storage box first, thereby completing the function of floor cleaning. Generally speaking, the automatic cleaning devices that complete sweeping, dust suction and floor wiping works are also collectively classified as the automatic cleaning devices.

There are many types of floor stains, and the traditional methods can only roughly cluster and segment the stains in an image, and are unable to determine the types of the stains and clean the stains effectively. At the same time, an operating environment of the automatic cleaning device is complex, and especially the illumination change has a larger impact on the RGB image, thereby affecting a stain detection effect and image depth calculation.

In view of this, the present application provides a floor stain detection method based on RGB camera image+green eye light supplement+structured light ranging (or RGBD, binocular, TOF)+spectrum-assisted recognition. Through the methods such as green eye enhanced image features, stain recognition model detection, multi-sensor fusion ranging and spectral image recognition, the types and positions of the stains can be accurately detected. After recognizing the stain type of a stain area, the automatic cleaning device controls a cleaning machine that can treat such a stain type to carry out corresponding treatment, thereby achieving accurate matching.

That is to say, according to the solution of the present application, the automatic cleaning device accurately detects the types and positions of stains. The floor stain detection method based on an RGB camera image, green eye light supplement, structured light ranging (or RGBD, binocular, TOF (time of flight)) and spectrum-assisted recognition can accurately detect the types and positions of the stains through methods such as green eye enhanced image features, stain recognition model detection, multi-sensor fusion ranging and spectral image recognition. After the automatic cleaning device recognizes the stain type of the stain area, a cleaning machine that can treat such a stain type is controlled to carry out corresponding treatment, thereby achieving accurate matching.

The conception of the present application is as follows: in a first step, a pixel position of the stain on the RGB image may be marked through a target detection model. In a second step, a space recognition part: 1) a depth camera will generate a depth image, and each pixel is depth information, which is converted into three-dimensional space coordinates; and 2) structured light ranging (that is, a line laser obstacle avoidance solution currently used on the machine): structured light generates a gray-scale image through a gray-scale camera, pixel positions of the structured light are found in the gray-scale image, and then three-dimensional coordinates of the pixel positions corresponding to the structured light may be calculated according to the structured light and internal and external parameters of the gray-scale camera. In a third step, according to the internal and external parameters, common view parts of the RGB image, the depth map and the structured light gray-scale image are overlapped together. In this way, the depth information, which is the three-dimensional coordinates of the recognized stain, can be acquired from an RGB recognition result (a box for target detection). After the three-dimensional coordinates are acquired, if the z axis of the three-dimensional coordinates is 0, it is considered as the floor and meets the requirements, and if the z axis of the three-dimensional coordinates is not 0, it is considered as misrecognition and filtered out.

In the present application, the stain area is recognized and detected by the RGB image (which may be monocular or binocular), and the type and contour of the stain are accurately recognized by means of target detection or semantic segmentation.

In the present application, distance information of the stain area relative to the automatic cleaning device is also accurately determined through depth ranging, which specifically includes:
1) single use of depth information of a depth camera (binocular stereo camera or ToF);
2) ranging of a target area by single use of structured light; and
3) fusion of depth information of the depth camera and structured light ranging.

In the present application, through a green eye/infrared light supplement lamp, the texture of the stain area can be enhanced and the identification degree of floor stain features is improved; and in a dim environment, the function of the light supplement lamp can also be achieved.

By adopting the solution of the present application and utilizing the spectral image for stain recognition, not only are the stain recognition result and position more accurate, but also the dry/wet state and turbidity degree of the stain can be further recognized, thereby providing information for a sweeping strategy of the automatic cleaning device.

At present, there are three types of mainstream depth cameras: structured light, TOF method and binocular stereo.

Basic principle of the structured light depth camera: main hardware consists of a projector and a camera. The projector actively emits (thus also referred to as “actively measures”) invisible (to naked eyes) IR infrared light to the surface of a measured object, one or more cameras then take pictures of the measured object to collect structured light images, the data is sent to a calculation unit, and the position and depth information is calculated and acquired through a triangulation principle, thereby achieving 3D reconstruction. The structured light, as its name implies, is to structure light, and there are many ways to project patterns, such as a sine fringe phase shift method, binary coded gray codes and phase shift method+gray codes.

Basic principle of the TOF depth camera: TOF is the time-of-flight method, that is, continuous light pulses are emitted to a target, the returned light is received by a sensor through reflection by the target, the TOF is recorded, and the distance to the target is calculated. Generally, there are two modes of pulse modulation and continuous wave modulation. Since the pulsed light is actively emitted, the TOF also belongs to an active measurement way. Unlike the binocular camera and structured light which can only output three-dimensional data through algorithm processing, the TOF can directly output the three-dimensional data of the measured object.

Basic principle of the binocular stereo depth camera: image information is acquired through left and right cameras to calculate a parallax, and the binocular camera does not actively emit a light source, and is thus called a passive depth camera.

Optionally, the floor stain may be recognized in the present application through the solutions of RGB camera, depth camera (RGBD or binocular stereo camera or TOF) and green eye/infrared light supplement lamp.

Optionally, the floor stain may be recognized in the present application through the solutions of RGB camera, infrared camera+structured light and green eye/infrared light supplement lamp.

Optionally, the floor stain may be recognized through the solutions of RGB camera, depth camera (RGBD or binocular stereo camera or TOF), infrared camera+structured light and green eye/infrared light supplement lamp.

Optionally, the floor stain may be recognized through the solutions of RGB camera, spectral camera, depth camera (RGBD or binocular stereo camera or TOF), infrared camera+structured light and green eye/infrared light supplement lamp.

The RGB-D depth camera (also known as 3D camera, where D stands for Depth, i.e., depth information) may acquire the distance information from an object to the camera, and with X and Y coordinates of a 2D plane, the three-dimensional coordinates of each point can be calculated. In this way, the applications of the depth camera such as three-dimensional reconstruction and target location and recognition can be inferred.

The following embodiments may be described in detail based on the above optional solutions.

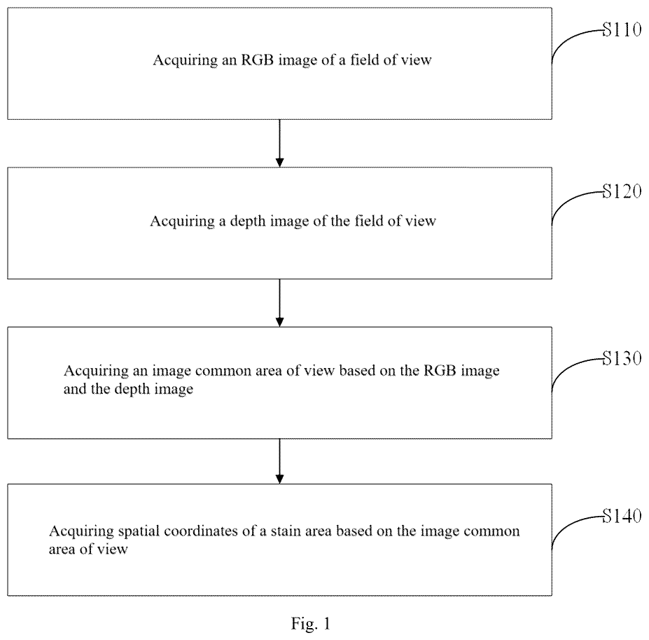

FIG. 1 shows a schematic flowchart of a floor stain recognition method according to a first embodiment of the present application. As can be seen from FIG. 1, the method of the present application at least includes steps S110 to S140.

In S110: an RGB image of a field of view is acquired.

Acquiring the RGB image of the field of view further includes: acquiring a stain area based on the RGB image.

Based on the RGB image collected by the RGB camera, stain features in the RGB image are acquired, and the stain features include a stain area and a stain type. The RGB image is acquired from the RGB camera, and the RGB image is subjected to preprocessing such as distortion, cropping and scale adjustment, and input into a well-trained stain recognition model.

By executing tasks such as image target detection and semantic segmentation, the stain type and coordinate values (pixel positions in the stain area) of the stain area in a pixel coordinate system are acquired. In a possible embodiment of the present application, acquiring the stain features in the RGB image based on the RGB image collected by the RGB camera further includes: preprocessing the RGB image to acquire a preprocessed image, the preprocessing methods including but not limited to distortion, cropping, scale adjustment, etc. on the image. The well-trained stain recognition model is called, and the processed image is input into the stain recognition model to acquire each pixel position of the stain and the stain type. Based on each pixel position (x, y) of the stain, the stain area is further acquired.

In S120: a depth image of the field of view is acquired.

In an embodiment, the depth image of the field of view is acquired by a depth camera or a structured light infrared camera or by a fusion of the two cameras.

Acquiring the depth image of the field of view by the depth camera includes the following step: acquiring a depth image only containing the floor based on the depth image, which specifically includes:
based on internal and external parameters of the depth camera and pixel depth values of the depth image, acquiring a floor image of the depth image.

The above step of “acquiring the floor image of the depth image” further includes: deleting obstacle pixels of the floor image and acquiring the floor image.

In an embodiment, acquiring the depth image of the field of view through the structured light infrared camera includes the following step:
acquiring a structured light gray-scale image collected by the structured light infrared camera, converting the structured light gray-scale image into the depth image, and acquiring the depth image only containing the floor based on ranging information of the structured light gray-scale image.

In an embodiment, the depth image of the field of view is acquired through the fusion of the two cameras, and then the depth image only containing the floor is acquired based on the depth image. The specific steps are as follows:
acquiring the depth image of the field of view collected by the depth camera, and acquiring a first floor image of the depth image based on the internal and external parameters of the depth camera and the pixel depth values of the depth image;
acquiring the structured light gray-scale image collected by the structured light infrared camera, converting the structured light gray-scale image into the depth image, and acquiring a second floor image of the depth image converted from the structured light gray-scale image based on the ranging information of the structured light gray-scale image; and

overlapping the first floor image with the second floor image, calculating a depth value difference between corresponding pixel points, discarding the pixel depths of the pixel points if the depth value difference exceeds a threshold, and acquiring an average pixel depth of the pixel points if the depth value difference is within a threshold range, so as to acquire the accurate depth image only containing the floor.

In S130: an image common area of view is acquired based on the RGB image and the depth image.

Acquiring the image common area of view based on the RGB image and the depth image further includes:
acquiring a stain area based on the RGB image; and
carrying out image alignment on the stain area and the depth image only containing the floor, and acquiring the image common area of view, all pixel points of the stain area in the image common area of view being in one-to-one correspondence to all pixel points of the stain area in the depth image.

In a possible embodiment of the present application, the depth image only containing the floor in the depth image is acquired based on the depth image collected by the depth camera, and the depth camera may adopt a binocular stereo camera or a TOF depth camera.

The depth image is a depth image collected by the depth camera, and the depth image provides depths of all positions in a visible range of the camera. According to the internal and external parameters, all floor parts visible to the depth camera are found out and marked, that is, the image only containing the floor is acquired.

In S140: spatial coordinates of the stain area are acquired based on the image common area of view.

Acquiring the spatial coordinates of the stain area based on the image common area of view further includes:
acquiring the spatial coordinates of the stain area based on the pixel depth values and pixel positions of the pixel points of the stain area in the image common area of view.

In a possible embodiment of the present application, all the pixel points in the image common area of view acquired after the image alignment on the depth image only containing the floor and the stain area acquired by the RGB image are in a corresponding relationship with all the pixel points in the depth image. The specific steps of implementing the alignment operation of the RGB image and the depth image are as follows: acquiring an internal reference matrix of the RGB camera, an internal reference matrix of the depth camera and an external reference rotation matrix and an offset matrix of the RGB camera and the depth camera; and traversing the coordinates of each pixel point in the depth image, and calculating the coordinates of a pixel point in the depth image corresponding to the pixel point in the RGB image according to a formula (which may refer to the prior art).

Acquiring the spatial coordinates of the stain based on the pixel depth values and pixel positions of the pixel points of the stain area in the image common area of view further includes: calculating the distance from each pixel point to the camera as the pixel depth value according to the pixel values of the depth image. According to different camera parameters, each depth value may correspond to one corresponding depth distance. After the image alignment on the depth image and the RGB image, all pixel points in the RGB image and all pixel points in the depth image are in a corresponding relationship, thereby acquiring the corresponding three-dimensional coordinates of each pixel in the image in a world coordinate system based on the position of the pixel and the depth information corresponding to the pixel point.

The spatial coordinates of the stain area in the pixel coordinate system are converted into the spatial coordinates of the stain area in coordinates of the automatic cleaning device.

Based on a real-time pose of the automatic cleaning device, the spatial coordinates of the stain area in the coordinates of the automatic cleaning device are converted into spatial coordinates of the stain area in a world coordinate system.

When the RGB image is acquired, the green-eye/infrared light supplement lamp is shone on the surface and edge of the stain. On one hand, the texture information of the stain area is enhanced, and the features of the RGB image are improved; on the other hand, spectral features of the stain area are enhanced, which plays a role of light supplement in dim conditions, so that the machine can clearly see the outline of an obstacle and a spectral recognition effect is improved.

In the first embodiment of the present application, the floor stain may be recognized through the solutions of RGB camera, depth camera (RGBD or binocular stereo camera or TOF) and green eye/infrared light supplement lamp; or in the first embodiment of the present application, the floor stain may be recognized through the solutions of RGB camera, structured light infrared camera and green eye/infrared light supplement lamp; or in the first embodiment of the present application, the floor stain may be recognized through the RGB camera, depth camera (RGBD or binocular stereo camera or TOF), infrared camera+structured light and green eye/infrared light supplement lamp.

A floor stain recognition method according to a second embodiment of the present application at least includes the following step:
acquiring an RGB image of a field of view.

Acquiring the RGB image of the field of view further includes: acquiring an RGB stain area based on the RGB image.

In an embodiment, stain features in the RGB image are acquired based on the RGB image collected by an RGB camera, wherein the stain features include a stain type and a stain area, and the RGB camera may be a monocular camera or a binocular camera.

In a possible embodiment of the present application, acquiring the RGB image of the field of view, and acquiring the stain area based on the RGB image further include:
preprocessing the RGB image to acquire a preprocessed image, the preprocessing methods including but not limited to distortion, cropping, scale adjustment, etc. on the image.

A well-trained stain recognition model is called, the processed image is input into the stain recognition model to acquire the stain features, the stain features specifically include the stain type and the stain area, the stain area may be acquired through pixel positions of the stain, and the pixel positions of the stain are coordinate values of the stain in a pixel coordinate system.

The method further includes: inputting the processed image into the stain recognition model, and acquiring the stain features by executing a target detection algorithm, a semantic segmentation algorithm or an image segmentation algorithm, wherein the stain features are the stain type and the coordinates of the stain in the pixel coordinate system. Exemplarily, if a parameter value calculated by the stain recognition model is 0.88, the stain is determined as a coffee stain, if the parameter value is 0.86, the stain is determined as a water stain, and if the parameter value is 0.7, the stain is determined as a yogurt stain.

A spectral image of the field of view is acquired.

The step of “acquiring the spectral image of the field of view” further includes: acquiring a spectral stain area based on the spectral image.

In an embodiment, based on the spectral image collected by a spectral camera, the stain features of the spectral image may be acquired, and the stain features include the stain type and the pixel positions of the stain.

In a possible embodiment of the present application, acquiring the spectral image of the field of view and acquiring the stain area based on the spectral image further include:
clustering the spectrum of each pixel point in the spectral image to acquire a spectral cluster; and
calling a spectral recognition model, and inputting each spectral cluster into the spectral recognition model to acquire the stain features, wherein the stain features specifically include the stain area and the stain type, and the stain area may specifically be the coordinate values of the stain in the pixel coordinate system. Exemplarily, an example is cola on a patterned tile floor, and the stain form is determined based on spectral intensities of different pixel positions.

An intersection of the stain area acquired based on the RGB image and the stain area acquired based on the spectral image is acquired, wherein the intersection is the selected stain area.

Correcting an RGB recognition result by using a spectral recognition result specifically includes: acquiring the RGB stain area based on the RGB image; acquiring the spectral image of the field of view, and acquiring the spectral stain area based on the spectral image; and acquiring the intersection of the RGB stain area acquired based on the RGB image and the spectral stain area acquired based on the spectral image, the intersection being the stain area.

Due to the spectral image for stain recognition, not only are the stain recognition result and position more accurate, but also the dry/wet state and turbidity degree of the stain can be further recognized, thereby providing information for a sweeping strategy of the automatic cleaning device.

The stain area acquired based on the spectral image is aligned with the stain area acquired based on the RGB image to acquire a common area of view (intersection) of the RGB image.

Based on the RGB image, by means of internal and external parameters of the RGB camera and the spectral camera, the spectral image is aligned with the common area of view of the RGB image, and the RGB recognition result is corrected by using the spectral recognition result. The correction includes: intersection acquisition by area recognition, secondary verification of a recognition category label, etc. Therefore, the RGB recognition result is more accurate, a final result is obtained, and the result is converted into a coordinate system of the RGB image.

In a possible embodiment of the present application, the step of “acquiring the intersection of the stain area acquired based on the RGB image and the stain area acquired based on the spectral image” further includes:
acquiring a common area of view of the stain area acquired based on the spectral recognition model and the stain area acquired based on the stain recognition model, wherein the common area of view is the intersection of the stain area acquired by the spectral recognition model and the stain area acquired by the stain recognition model;
calling a recognition category label model, and determining whether the stain type acquired based on the spectral recognition model is consistent with the stain type acquired based on the stain recognition model; and
if the two stain types are the same, selecting the stain type; and if the two stain types are different, not selecting the stain type.

It should be noted that the steps of “acquiring the RGB image of the field of view” and “acquiring the spectral image of the field of view” in the present application are not limited in order. The above steps of “acquiring the RGB image of the field of view” to “acquiring the intersection of the stain area acquired based on the RGB image and the stain area acquired based on the spectral image” are image recognition parts; the step of “acquiring the RGB image of the field of view” is a process of acquiring the RGB recognition result; the step of “acquiring the spectral image of the field of view” is a process of acquiring the spectral recognition result; and the step of “acquiring the intersection of the stain area acquired based on the RGB image and the stain area acquired based on the spectral image” is a process of fusing the RGB and the spectrum.

The spectral recognition result is configured to correct the RGB recognition result to acquire the final result, and then the final result is converted to the coordinate system of the RGB image. The fusion of the RGB and the spectrum is in the pixel coordinate system, and is then converted to the coordinate system of the automatic cleaning device after recognition by the spatial recognition module.

A depth image of the field of view is acquired.

Acquiring the depth image of the field of view further includes: acquiring a depth image only containing the floor based on the depth image. In an embodiment, the depth image of the field of view is acquired by fusing a depth camera and a structured light infrared camera, thereby acquiring the depth image only containing the floor based on the depth image. The specific steps are as follows:
acquiring the depth image of the field of view collected by the depth camera, and acquiring a first floor image of the depth image based on internal and external parameters of the depth camera and pixel depth values of the depth image; and
acquiring a structured light gray-scale image collected by the structured light infrared camera, converting the structured light gray-scale image into the depth image, and acquiring a second floor image of the depth image converted from the structured light gray-scale image based on ranging information of the structured light gray-scale image.

It should be explained that installation positions of the structured light camera and the gray-scale camera are fixed, and an emission angle of the light emitted by the structured light is also fixed. There is a one-to-one correspondence between the positions where the structured light is shone on obstacles (three-dimensional coordinates in the camera coordinate system) and the pixels on the structured light gray-scale image, that is, the acquired three-dimensional coordinates are the ranging information. Exemplarily, if the z axis of the three-dimensional coordinates is 0 (actually used nearby 0), it is the floor, and if it is greater than 0, it is the obstacle.

Converting the structured light gray-scale image into the depth image further includes: turning on the structured light, acquiring a gray-scale image with structured light information from the infrared camera, calculating distance information between the automatic cleaning device and the floor or the obstacle by the infrared camera and calibration parameters of the structured light, and marking the depth information in the gray-scale image.

The first floor image is overlapped with the second floor image, a depth value difference between corresponding pixel points is calculated, the pixel depths of the pixel points are discarded if the depth value difference exceeds a threshold, and an average pixel depth of the pixel points is acquired if the depth value difference is within a threshold range, thereby acquiring the accurate depth image only containing the floor.

The depth image provided by the depth camera provides depths of all positions in the visible range of the camera. According to the internal and external parameters, all floor parts visible to the camera are found out and marked, that is, the image only containing the floor is acquired.

The depth camera of the present application is selected from any one of the RGBD, binocular stereo camera and TOF.

In another possible embodiment, the depth image of the field of view is only acquired by the depth camera, and acquiring the depth image only containing the floor based on the depth image further includes:
acquiring the depth image of the field of view collected by the depth camera, and acquiring the floor image of the depth image based on the internal and external parameters of the depth camera and the pixel depth values of the depth image.

The depth camera may be the binocular stereo camera or the TOF depth camera.

Acquiring the gray-scale image collected by the structured light infrared camera and converting into the depth image specifically include: turning on the structured light, acquiring the gray-scale image with structured light information from the infrared camera, calculating the distance information between the automatic cleaning device and the floor or the obstacle by the infrared camera and the calibration parameters of the structured light, and marking the gray-scale image with depth information. The gray-scale image is converted into the depth image (of course, only the part corresponding to the structured light has depth), which is then fused with the RGB image to provide the depth information.

When the solution of fusing the depth camera and the structured light infrared camera is adopted, based on the above steps, the gray-scale image collected by the structured light infrared camera is acquired and converted into the depth image. It is also necessary to align the two images to find the depth value difference between the corresponding pixel points and acquire a more accurate depth image. If the solution of the depth camera and the structured light infrared camera is adopted for secondary verification, the accuracy of the depth image of the field of view is further improved. Specifically, the first floor image and the second floor image are overlapped, and the depth value difference between the corresponding pixel points is calculated. If the depth value difference exceeds the threshold, the pixel depths of the pixel points are discarded. If the depth value difference is within the threshold range, the average pixel depth of the pixel points is acquired, and then the accurate depth image only containing the floor is acquired.

The image common area of view is acquired based on the RGB image and the depth image.

Acquiring the image common area of view based on the RGB image and the depth image further includes: aligning the depth image only containing the floor with the stain area acquired by the RGB image to acquire the image common area of view, wherein all pixel points of the stain area in the image common area of view being in one-to-one correspondence to all pixel points of the stain area in the depth image.

The so-called image alignment includes based on the RGB camera, converting the depth image and the structured light gray-scale image into the coordinate system of the RGB camera by means of the internal and external parameters of the camera to acquire the image common area of view.

The depth camera will generate the depth image, each pixel is depth information, and each pixel of the depth image is converted into three-dimensional space coordinates.

The spatial coordinates of the stain area are acquired based on the pixel depth values and pixel positions of the pixel points of the stain area in the image common area of view.

The spatial coordinates of the stain area in the pixel coordinate system are converted into the spatial coordinates of the stain area in the coordinates of the automatic cleaning device.

For the stain on the floor, the floor position information is assigned to the stain and converted to the coordinate system of the automatic cleaning device. The floor position information may be acquired by the three-dimensional coordinates of respective pixel points on the floor in the camera coordinate system.

Based on a real-time pose of the automatic cleaning device, the spatial coordinates of the stain area in the coordinates of the automatic cleaning device are converted into the spatial coordinates of the stain area in the world coordinate system.

The real-time pose of the automatic cleaning device is acquired, and the coordinates of the stain area in the coordinate system of the automatic cleaning device are converted into the coordinates in the world coordinate system, which are marked on a sweeping map.

When the RGB image is acquired, the green-eye/infrared light supplement lamp is shone on the surface and edge of the stain. On one hand, the texture information of the stain area is enhanced, and the features of the RGB image are enhanced; on the other hand, spectral features of the stain area are enhanced, which plays a role of light supplement in dim conditions, so that the machine can clearly see the outline of an obstacle and a spectral recognition effect is improved. In the second embodiment of the present application, the floor stain can be recognized through the solutions of RGB camera, spectral camera, depth camera (RGBD or binocular stereo camera or TOF), structured light+infrared camera and green eye/infrared light supplement lamp.

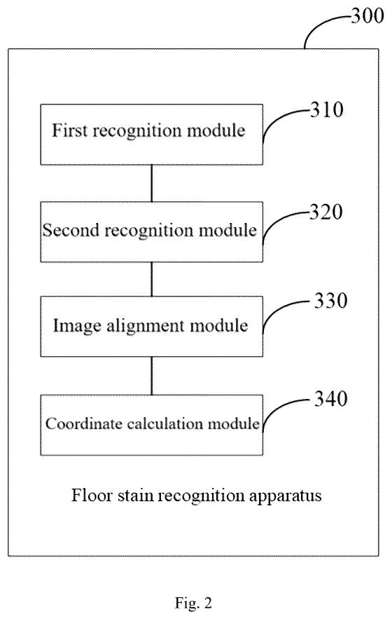

FIG. 2 shows a schematic structural diagram of a floor stain recognition apparatus according to a third embodiment of the present application. The floor stain recognition apparatus is applied to the automatic cleaning device. As can be seen from FIG. 2, the floor stain recognition apparatus 300 includes:
a first recognition module 310, configured to acquire an RGB image of a field of view;
a second recognition module 320, configured to acquire a depth image of the field of view;
an image alignment module 330, configured to acquire an image common area of view based on the RGB image and the depth image; and
a coordinate calculation module 340, configured to acquire spatial coordinates of the stain area based on the image common area of view.

In a possible embodiment, the image alignment module 330 is further configured to acquire the stain area based on the RGB image; acquire a depth image only containing the floor based on the depth image; and align the stain area and the depth image only containing the floor, and acquire the image common area of view, all pixel points of the stain area in the image common area of view being in one-to-one correspondence to all pixel points of the stain area in the depth image.

In a possible embodiment, the coordinate calculation module 340 is further configured to acquire the spatial coordinates of the stain area based on pixel depth values and pixel positions of the pixel points of the stain area in the image common area of view.

In a possible embodiment, the first recognition module 310 is further configured to: preprocess the RGB image to acquire a preprocessed image; and call a well-trained stain recognition model, and input the preprocessed image into the stain recognition model to acquire the stain area.

In a possible embodiment, the image alignment module 330 is further configured to acquire a spectral image of the field of view, and acquire the stain area based on the spectral image; and acquire an intersection of the stain area acquired based on the RGB image and the stain area acquired based on the spectral image, the intersection being the selected stain area.

In a possible embodiment, calling the trained stain recognition model to acquire the stain area further includes:
inputting the preprocessed image into the stain recognition model, and acquiring a stain type and the stain area by executing a target detection algorithm, a semantic segmentation algorithm or an image segmentation algorithm, the stain area being coordinates of a stain in a pixel coordinate system.

In a possible embodiment, the second recognition module 320 is further configured to cluster a spectrum of each pixel point in the spectral image to acquire a spectral cluster; and
call a spectral recognition model, and input each spectral cluster into the spectral recognition model to acquire stain features, the stain features specifically including the stain area and the stain type.

In a possible embodiment, the second recognition module 320 is further configured to call a recognition category label model, and determine whether the stain type acquired based on the spectral recognition model is consistent with the stain type acquired based on the stain recognition model; if the two stain types are the same, select the stain type; and if the two stain types are different, not select the stain type.

In a possible embodiment, the coordinate calculation module 340 is configured to convert the spatial coordinates of the stain area in the pixel coordinate system into spatial coordinates of the stain area in coordinates of the automatic cleaning device; and convert the spatial coordinates of the stain area in the coordinates of the automatic cleaning device into spatial coordinates of the stain area in a world coordinate system based on a real-time pose of the automatic cleaning device.

It should be noted that the above floor stain recognition apparatus can implement the floor stain recognition method in the first embodiment one by one, and the same technical features as the floor stain recognition method are not described here.

The present application further discloses an automatic cleaning device according to a fourth embodiment. The automatic cleaning device includes an automatic cleaning device body and a controller for controlling the automatic cleaning device body, wherein the controller adopts the above floor stain recognition method in the first embodiment.

The above apparatus corresponds to the method embodiments and has the same technical effects as the method embodiments. Please refer to the method embodiments for details. The apparatus embodiment is obtained based on the method embodiments, and the detailed illustration may refer to the method embodiment section, which is not repeated here. It can be understood by a person of ordinary skill in the art that the accompanying drawings are only schematic diagrams of one embodiment, and the modules or the flowcharts in the accompanying drawings may not be necessary for implementing the present disclosure.

It can be understood by a person of ordinary skill in the art that the modules in the apparatus of the embodiment may be distributed in the apparatus of the embodiment according to the description of the embodiment, or may be correspondingly varied to be located in one or more apparatuses different from the embodiment. The modules in the above embodiment may be combined as one module, or may be further divided into several sub-modules.

Finally, it should be noted that the above embodiments are only used for illustrating the technical solutions of the present disclosure instead of limiting the same. Although the present disclosure has been described in detail with reference to the foregoing embodiments, it should be understood by a person of ordinary skill in the art that the technical solutions recorded in the foregoing embodiments can still be modified or some technical features thereof can be equivalently substituted. However, these modifications or substitutions do not make the essence of the corresponding technical solutions deviate from the spirit and scope of the technical solutions of the embodiments of the present disclosure.

1. A floor stain recognition method, comprising:
acquiring an RGB image of a field of view;
acquiring a depth image of the field of view;
acquiring an image common area of view based on the RGB image and the depth image; and
acquiring spatial coordinates of a stain area based on the image common area of view.

2. The floor stain recognition method according to claim 1, wherein acquiring the RGB image of the field of view further comprises: acquiring the stain area based on the RGB image.

3. The floor stain recognition method according to claim 1, wherein acquiring the RGB image of the field of view further comprises:
acquiring an RGB stain area based on the RGB image;
acquiring a spectral image of the field of view, and acquiring a spectral stain area based on the spectral image; and
acquiring an intersection of the RGB stain area acquired based on the RGB image and the spectral stain area acquired based on the spectral image, the intersection being the stain area.

4. The floor stain recognition method according to claim 2, wherein acquiring the depth image of the field of view further comprises:
acquiring a depth image only containing the floor based on the depth image.

5. The floor stain recognition method according to claim 4, wherein acquiring the spatial coordinates of the stain area based on the image common area of view further comprises:
carrying out image alignment on the stain area and the depth image only containing the floor, and acquiring the image common area of view, all pixel points of the stain area in the image common area of view being in one-to-one correspondence to all pixel points of the stain area in the depth image.

6. The floor stain recognition method according to claim 5, wherein acquiring the spatial coordinates of the stain area based on the image common area of view further comprises:
acquiring the spatial coordinates of the stain area based on pixel depth values and pixel positions of the pixel points of the stain area in the image common area of view.

7. The floor stain recognition method according to claim 2, wherein acquiring the stain area based on the RGB image further comprises:
preprocessing the RGB image to acquire a preprocessed image; and
calling a trained stain recognition model, and inputting the preprocessed image into the stain recognition model to acquire the stain area.

8. The floor stain recognition method according to claim 7, wherein calling the trained stain recognition model to acquire the stain area further comprises:
inputting the preprocessed image into the stain recognition model, and acquiring a stain type and the stain area by executing a target detection algorithm, a semantic segmentation algorithm or an image segmentation algorithm, the stain area being coordinates of a stain in a pixel coordinate system.

9. The floor stain recognition method according to claim 3, wherein acquiring the spectral image of the field of view and acquiring the stain area based on the spectral image further comprises: clustering a spectrum of each pixel point in the spectral image to acquire a spectral cluster; and
calling a spectral recognition model, and inputting each spectral cluster into the spectral recognition model to acquire stain features, the stain features specifically comprising the stain area and the stain type.

10. The floor stain recognition method according to claim 9, further comprising:
calling a recognition category label model, and determining whether the stain type acquired based on the spectral recognition model is consistent with the stain type acquired based on the stain recognition model; and
if the two stain types are the same, selecting the stain type; and if the two stain types are different, not selecting the stain type.

11. The floor stain recognition method according to claim 1, wherein the depth image of the field of view is acquired by a depth camera or a structured light infrared camera or a fusion of both.

12. The floor stain recognition method according to claim 11, wherein
the depth camera is selected from any one of an RGBD, a binocular stereo camera and TOF; or
wherein acquiring the depth image of the field of view by fusing the structured light infrared camera and the depth camera further comprises: acquiring the depth image only containing the floor based on the depth image.

13. The floor stain recognition method according to claim 12, wherein acquiring the depth image only containing the floor based on the depth image further comprises:
acquiring the depth image of the field of view collected by the depth camera, and acquiring a first floor image based on the depth image;
acquiring a structured light gray-scale image collected by the structured light infrared camera, and acquiring a second floor image based on the structured light gray-scale image; and
overlapping the first floor image with the second floor image to acquire the depth image only containing the floor.

14. The floor stain recognition method according to claim 13, wherein acquiring the first floor image based on the depth image further comprises: acquiring the first floor image of the depth image based on internal and external parameters of the depth camera and pixel depth values of the depth image.

15. The floor stain recognition method according to claim 13, wherein
acquiring the second floor image based on the structured light gray-scale image further comprises: converting the structured light gray-scale image into the depth image, and acquiring the second floor image of the depth image converted from the structured light gray-scale image based on ranging information of the structured light gray-scale image.

16. The floor stain recognition method according to claim 13, wherein overlapping the first floor image with the second floor image to acquire the depth image only containing the floor further comprises:
calculating a depth value difference between corresponding pixel points, discarding the pixel depths of the pixel points if the depth value difference exceeds a threshold, and acquiring an average pixel depth of the pixel points if the depth value difference is within a threshold range, and further acquiring the depth image only containing the floor.

17. The floor stain recognition method according to claim 11, further comprising:
shining a green eye/infrared light supplement lamp on a surface and an edge of the stain when acquiring the RGB image or spectral image.

18. The floor stain recognition method according to claim 17, wherein the spatial coordinates of the stain area in the pixel coordinate system are converted into spatial coordinates of the stain area in coordinates of the automatic cleaning device; and
the spatial coordinates of the stain area in the coordinates of the automatic cleaning device are converted into spatial coordinates of the stain area in a world coordinate system based on a real-time pose of the automatic cleaning device.

19. A floor stain recognition apparatus, comprising:
a first recognition module, configured to acquire an RGB image of a field of view;
a second recognition module, configured to acquire a depth image of the field of view;
an image alignment module, configured to acquire an image common area of view based on the RGB image and the depth image; and
a coordinate calculation module, configured to acquire spatial coordinates of the stain area based on the image common area of view.

20. An automatic cleaning device, comprising an automatic cleaning device body and a controller for controlling the automatic cleaning device body, the controller adopting a floor stain recognition method, comprising:
acquiring an RGB image of a field of view;
acquiring a depth image of the field of view;
acquiring an image common area of view based on the RGB image and the depth image; and
acquiring spatial coordinates of a stain area based on the image common area of view.
